(19) United States
(12) Patent Application Publication
(10) Pub. No.: US 2009/0277191 A1
(43) Pub. Date: Nov. 12, 2009

(54) Ice Preparation Device, Corresponding Tray and Method for Preparing Ice

(75) Inventors: Bernd Heger, Haunsheim (DE); Tom St Quintin, London (GB); Craig Duncan Webster, Cambridgeshire (GB); Nathan Wrench, Cambridgeshire (GB)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgeräte GmbH, Munich (DE)

(21) Appl. No.: 11/795,585

(22) PCT Filed: Nov. 30, 2005
(86) PCT No.: PCT/EP2005/056348

§ 371 Date: May 27, 2008

(30) Foreign Application Priority Data
Jan. 24, 2005 (DE) 10 2005 003 236.2

(51) Int. Cl. F25C 1/00; F25C 5/08; F25C 1/10; B28B 7/42

(52) U.S. Cl. 62/66; 62/351; 62/345; 249/78

(57) ABSTRACT

A tray (1) pivotably mounted in an automatic ice maker has a plurality of compartments (4) arranged in a number of rows and separated from one another by partition walls. The wall (6) extending above the upper edges of the partition walls (3) is formed at a longitudinal side of each row of compartments (4) and at at least a part of the transverse sides (2) thereof.

For ice making, water (10) is filled into the tray (1) and allowed to freeze therein. Prior to letting the freezing take place, the tray (1) is pivoted from a tilted setting, in which the filled water (10) floods over the partition walls (3) between the compartments (4) of the tray (1) on a part of the width thereof and contacts a region of the longitudinal wall (6) extending above the upper edges of the partition walls (3), to an upright setting, in which the level of the water (10) lies below the upper edges of the partition walls (3).

The present invention relates to an ice-maker tray with a plurality of compartments arranged in a number of rows and separated from one another by partition walls, to an ice maker in which such a tray is usable and to a method, which can be carried out with the tray or the ice maker, for producing ice.

A conventional ice-maker tray as well as an automatic ice maker in which such a tray is used are known from, for example, U.S. Pat. No. 6,571,567 B2.In the case of this known ice maker the compartments are arranged in two rows each of four compartments and the entire arrangement of eight compartments has at its outer circumference an encircling wall which extends above the upper edge of the partition walls between the compartments.

Such a protruding wall makes it possible, when during filling of water into the tray a compartment overflows, for the water to spread into an adjacent compartment without flowing down from the tray at the sides, so that the water, even if it is initially filled into only a single compartment, successively reaches and fills up all compartments.

Such an ice block tray is not completely satisfactory, since it is very difficult to produce ice blocks of the same size. If the water is poured into only a single compartment and the adjacent ones are filled by overflowing, the water level in the compartment, into which it was poured, lies, after the filling, higher than the upper edges of the partition walls surrounding the compartment due to the surface tension of the water, whereagainst the compartments furthest from the pour-in compartment frequently remain incompletely filled. In order to completely fill all compartments it is necessary to pour in so much water that the partition walls are flooded over, so that individual ice blocks are not obtained, but a cohesive block which has to be broken up into individual pieces after freezing. It is unhygienic to break up with bare hands and manual breaking up with the help of a tool is laborious. In the case of automatic ice making there is the additional problem that the cohering pieces of ice demand a relatively large amount of space in a storage container in which they are collected after being made.

In order to alleviate this problem ice-maker trays have been proposed in which there are formed, in the upper edges of the partition walls, respective notches which facilitate overflowing of water from a full compartment to an adjacent compartment still capable of receiving. However, here the problem also results that a uniform distribution of water to the chambers is not achieved as long as the water-filled cross-section of the notches is so small that the surface tension influences the throughflow of water and that, if the cross-section of the notches is enlarged in order to reduce the influence of the surface tension, cohering pieces of ice are obtained.

The object of the present invention is to indicate an ice-maker tray or an ice maker or a method of ice making which makes it possible, by simple means, to produce individual pieces of ice which are reliably separated from one another and have uniform dimensions.

The object is fulfilled by an ice-maker tray with the features of claim 1. Due to the fact that a wall extending above the upper edge of the partition walls is formed at a longitudinal side of each row of compartments as well as at at least a part of the transverse sides thereof the possibility is created, by an inclined setting of the tray, of enabling crossing of water from one compartment to another over a large cross-sectional area substantially uninfluenced by surface tension effects, so that the same water states result in each compartment, and of cleanly separating the water bodies in the individual compartments from one another by subsequent placing of the tray upright, so that non-cohering pieces of ice are obtained when freezing.

The number of rows in the ice-maker tray is preferably one. It is, in fact, conceivable to produce an ice-maker tray of the above-described kind with any number of rows, but in the case of such a tray the protruding walls must prevent exchange of water between adjacent rows so that water from the other rows cannot collect in the row which is lowermost in the inclined state. Standardisation of the volumes of the pieces of ice is therefore possibly only within one row.

In order to achieve, in the inclined state, a sufficient cross-section for the passage of water between the compartments the wall should protrude at least 5 millimetres above the upper edge of the partition walls.

In order to facilitate removal of the finished pieces of ice from the mould the compartments preferably have the shape of a segment of a circle in cross-section. A piece of ice can be removed from these compartments particularly simply in that it slides in circumferential direction of the circle segment without, as in the case of a conventional block-shaped piece of ice of the kind under consideration in, for example, U.S. Pat. No. 6,571,567 B2,formation, during removal from the mould, between the base of the compartment and the ice body of a cavity which prevents removal as long as there is no equalisation of an underpressure prevailing in the cavity.

An electrical heating device can be provided at the ice-maker tray in order to accelerate and facilitate mould removal of finished pieces of ice through thawing at the surface.

In order to achieve an intensive heat exchange with the environment the tray can be provided with protruding exchange heat exchange ribs. These ribs can at the same time serve for mounting a rod-shaped heating device inserted therebetween.

The object is further fulfilled by an ice maker with an ice-maker tray of the above-described kind and a frame in which the tray is pivotable about an axis between an upright setting, in which the upper edges of the partition walls extend horizontally, and a tilted setting, in which they are inclined towards the longitudinal side having the protruding wall.

In order to make the ice maker compact, the centre axis of a notional smallest cylinder enclosing the tray is preferably selected as pivot axis.

The upper edges of the partition walls preferably lie above the pivot axis in the upright and the tilted setting. A large cross-sectional area of the compartments with, at the same time, compact external dimensions of the ice maker can thereby be realised.

For removal of the ice cubes the tray is preferably pivotable into an emptying setting in which the openings of the compartments face downwardly, so that pieces of ice contained therein can slide out under their own weight.

Finally, the task is fulfilled by a method for making ice, comprising the steps of filling water into an ice-maker tray and letting the water in the tray freeze, in which prior to letting the freezing take place the ice-maker tray is pivoted from a tilted setting, in which the filled water floods over partition walls between compartments of the tray on a part of the width thereof and contacts a region of a longitudinal wall extending above the upper edges of the partition walls, to an upright setting, in which the level of the water lies below the upper edges of the partition walls.

Further features and advantages of the invention are evident from the following description of examples of embodiment with reference to the accompanying figures, in which:

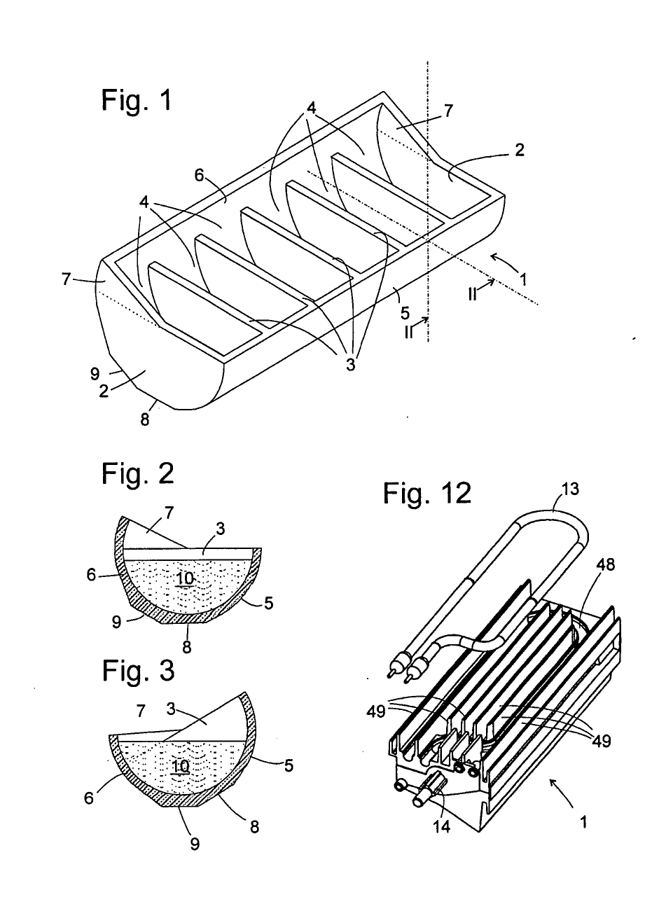

FIG. 1 shows a perspective view of an ice-maker tray according to a first elementary embodiment of the invention;

FIG. 2 shows a section through the ice-maker tray of FIG. 1 in upright state;

FIG. 3 shows a section through the ice-maker tray of FIG. 1 in tilted state;

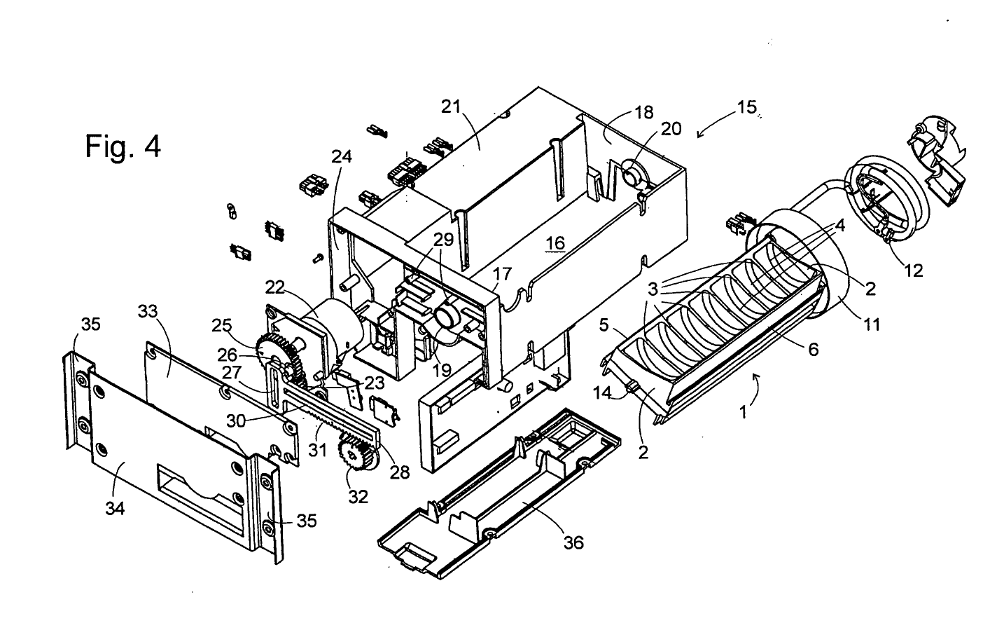

FIG. 4 shows an exploded illustration of an automatic ice maker according to a developed embodiment of the invention;

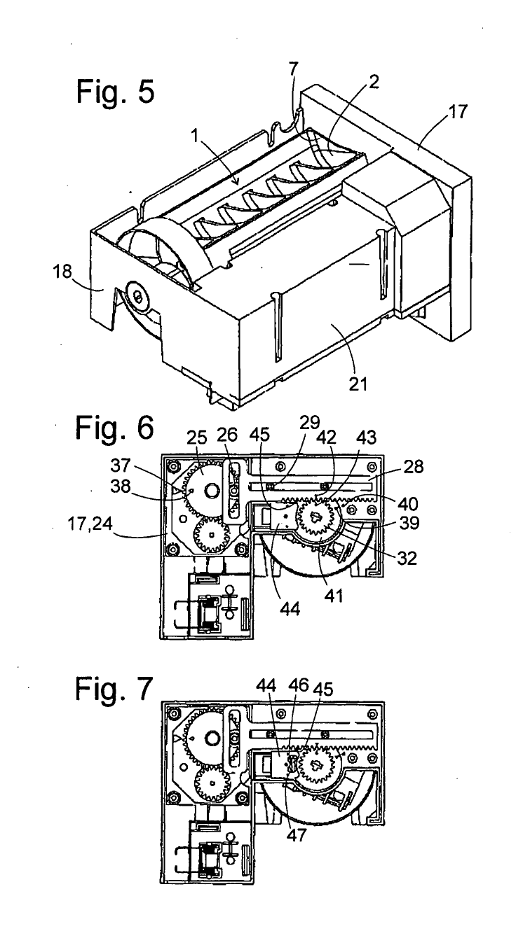

FIG. 5 shows a perspective view of the ice maker of FIG. 4 in assembled state with ice-maker tray in tilted setting;

FIG. 6 shows a section through the ice maker of FIG. 5 in the plane denoted by VI-VI;

FIG. 7 shows the section of FIG. 6 with partly cut-away sensor housing;

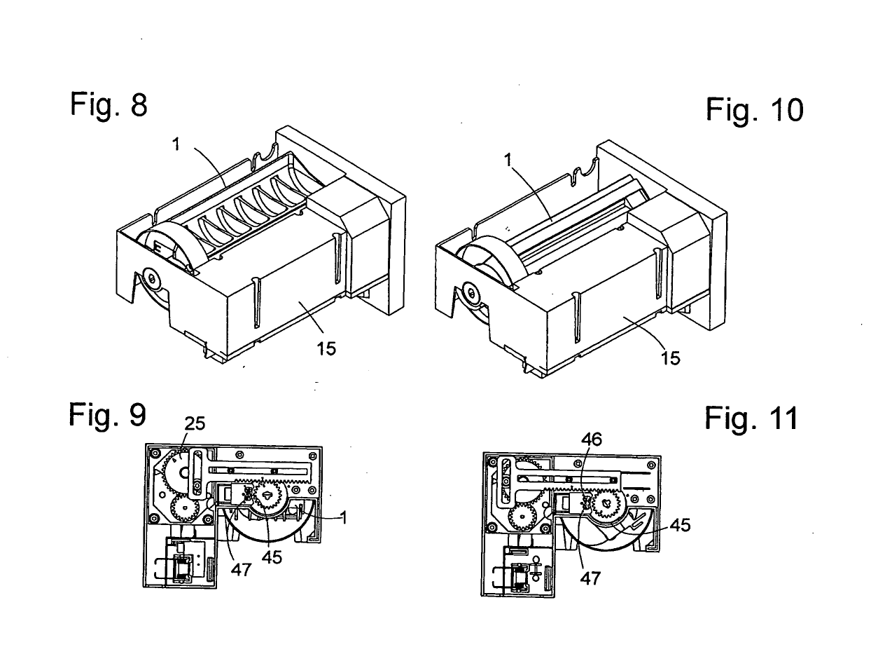

FIG. 8 shows a view, which is analogous to FIG. 5, with ice-maker tray in upright setting;

FIG. 9 shows a section, which is analogous to FIG. 7, with the ice-maker tray in upright setting;

FIG. 10 shows a perspective view analogous to FIGS. 5 and 8 with the ice-maker tray in emptying setting;

FIG. 11 shows a sectional analogous to FIGS. 7 and 9; and

FIG. 12 shows a perspective, exploded view from below of the ice-maker tray.

FIG. 1 is a perspective view of an elementary embodiment of an ice-maker tray according to the present invention, which is usable as an accessory in a freezing appliance. The tray 1 is a moulded part of solid plastics material, in the form of a channel with a semi-cylindrical base, which is closed at the ends thereof by respective transverse walls 2 and is subdivided by partition walls 3, which are arranged at uniform spacings, into a plurality of identically shaped compartments 4, here six units. Whereas the partition walls 3 at the longitudinal wall 5 facing the viewer adjoin flushly, the longitudinal wall 6 remote from the viewer is prolonged above the upper edges of the partition walls 3. Whilst the partition walls 3 are exactly semicircular, the transverse walls 2 each have, in correspondence with the protrusion of the rearward longitudinal wall 6, a sector 7 going out beyond the semicircular shape.

At the outer circumference of the tray 1 the longitudinal walls 5, 6 are connected by two planar surfaces 8, 9. In the setting of FIG. 1 the planar surface 8 forms the support surface of the tray 1. FIG. 2 shows a section through the tray 1 in the plane denoted by dot-dashed lines II, II in FIG. 1. The compartments 4 are here filled with water 10; the water level extends below the upper edges of the partition walls 3 parallel thereto.

FIG. 3 shows the same tray in a tilted state, resting on the planar surface 8 adjoining the elevated longitudinal wall 6. The water level is here parallel to the upper edges of the sectors 7 of the transverse walls 2, whilst the partition walls 3 are washed over by the water 10 on a part of their width, as indicated by a dashed line. In this setting water can flow freely from one compartment 4 to another so that the same water level sets in in all compartments. In this setting the tray 1 can be filled with water. In order to subsequently freeze the water into pieces cleanly separated from one another the tray 1 is placed in a freezing compartment in the setting shown in FIG. 2.

FIG. 4 shows an automatic ice cube maker according to the present invention in an exploded perspective view. Elements of this ice maker, which are functionally comparable with those of the tray of FIG. 1, are denoted by the same reference numerals. There can be recognised the tray 1, which is reproduced in an orientation approximately corresponding with the setting of FIG. 3, with seven compartments 4 delimited from one another by partition walls 3. A longitudinal wall 5 remote from the viewer is flush with the upper edges of the partition walls 3, whilst a longitudinal wall 6 facing towards the viewer is prolonged above the upper edges of the partition walls 3. The tray 1 can be a plastics material moulded part, but preferably, due to the good thermal conductivity, it is constructed as a cast part of aluminium.

A hollow cylinder 11 is mounted at one of the transverse walls 2 of the tray 1; it serves for protected accommodation of a coiled power supply cable 12 serving for supply of current to a heating device 13, which is not visible in the figure, accommodated at the underside of the tray 1 (see FIG. 12). The tray 1 lies completely within a notional prolongation of the circumferential surface of the hollow cylinder 11, which at the same time represents the smallest possible cylinder into which the tray fits. An axial spigot 14, which protrudes from the transverse wall 2 facing the viewer, extends on longitudinal centre axis of the hollow cylinder 11.

A frame moulded from plastics material is denoted by 15. It has an upwardly and downwardly open cavity 16 which is provided for mounting of the tray 1 therein. Bearing bushes 19, 20 for the pivotable mounting of the tray 1 are formed at the end walls 17, 18 of the cavity 16. A longitudinal wall of the cavity 16 is formed by a box 21, which is provided for reception of a drive motor 22 as well as various electronic components for control of operation of the ice maker. Mounted on the shaft of the drive motor 22 is a pinion 23 which can be better seen in each of FIGS. 6, 7, 9 and 11 than in FIG. 2. When the ice maker is in fully mounted state the pinion 23 finds space in a cavity 24 of the end wall 17. It forms there, together with a gearwheel 25, a speed step-down transmission.

The gearwheel 25 carries a pin 26 which protrudes in axial direction and which is provided for engaging in a vertical slot 27 of an oscillatory body 28. The oscillatory body 28 is guided to be horizontally displaceable with the help of pins 29 which protrude from the end wall 17 into the cavity 24 and which engage in a horizontal slot 30 of the oscillatory body. A toothing 31 formed at a lower edge of the oscillatory body 28 meshes with a gearwheel 32, which is provided for the purpose of being plugged onto the axial spigot 14 of the tray 1 to be secure against rotation relative thereto.

A cover plate 33 screw-connected to the open side of the end wall 17 closes the cavity 24. A fastening flange 34 with a strap 35 protruding beyond the end wall 17 serves for mounting the ice maker in a refrigerating appliance. A base plate 36 closes the box 21 at the bottom.

FIG. 5 shows, as seen from the side of the end wall 18 and the box 21, the ice maker with the tray 1 in tilted setting in perspective view. The upper edges of the sectors 7 at the transverse walls 2 of the tray 1 extend horizontally.

FIG. 6 shows a front view of the ice maker from the side of the end wall 17, wherein cover plate 33 and fastening flange 34 have been omitted in order to give free view into the cavity 24 of the end wall 17. The configuration shown here is that in which the ice maker is mounted together. Diverse markings indicate a correct positioning of individual parts relative to one another. A first pair of markings 37, 38 is disposed at the end wall 17 itself, or at the gearwheel 25 carrying the pin 26. When these markings 37, 38 are, as shown in the figure, aligned exactly with one another the pin 26 is disposed in a 3 o'clock setting, i.e. on the point, which lies furthest to the right in the perspective view of the figure, of its path which it can reach. The oscillatory body 28 plugged onto the pin 26 as well as onto the stationary pin 29 is disposed at the righthand reversal point of its path.

Markings 39, 40, which are aligned with one another, at a flange 41 of the gearwheel 32 protruding beyond the tooth rim and at the end wall 17 indicate a correct orientation of the gearwheel 32 and as a consequence thereof also of the tray 1 engaging by its axial spigot 14 in a cut-out, which is T-shaped in cross-section, of the gearwheel 32. A pair, which is redundant per se, of markings 42, 43 at the toothing 31 of the pivot body 28 and at the gearwheel 32 show the correct positioning of gearwheel 32 and oscillatory body 31 with respect to one another.

A sensor 44 for detecting the rotational setting of the gearwheel 32 is mounted near this. It co-operates with a rib 45, which protrudes in axial direction from the edge of the flange 41 on a part of the circumference thereof so that it can enter into a slot at the rear side of the sensor housing. In the tilted setting of FIG. 6 the rib 45 is for the greatest part covered by the sensor 44 and the oscillatory body 28. FIG. 7 differs from FIG. 6 in that the housing of the sensor 44 is shown in part cut away so that two light barriers 46, 47 bridging over the slot can be recognised in its interior. The rib 45 is disposed closely above the two light barriers 46, 47 so that a control electronic system, which is not illustrated, can recognise, on the basis of the fact that the two light barriers are open, that the tray 1 is disposed in the tilted setting and can stop the drive motor 22 in order to be able to keep the tray 1 in the tilted setting and fill it.

After a predetermined water quantity has been admetered into the tray 1 under the control of the control circuit the drive motor 22 is set in operation by the control unit in order to bring the tray 1 into the upright setting in which the water quantities in the compartments 4 of the tray 1 are cleanly separated from one another. This setting is shown in FIG. 8 in a perspective view corresponding with FIG. 5 and in FIG. 9 in a front view corresponding with FIG. 7. The gearwheel 25 is further rotated in clockwise sense relative to the setting of FIG. 7, although the same setting of the tray 1 can also be reached by rotation of the gearwheel 25 in counter-clockwise sense. Attainment of the upright setting is recognised when the rib 45 begins to block the lower light barrier 47.

The tray 1 remains in the upright setting for such a length of time until the water in the compartments 4 is frozen. The dwell time in the upright setting can be fixedly predetermined; alternatively, the control circuit can also be connected with a temperature sensor in order to be able to establish, on the basis of a measured temperature in the environment of the tray 1 and a characteristic curve stored in the control circuit, a respective time period sufficient in the case of the measured temperature for freezing the water.

After expiry of this time period the drive motor 22 is set back into operation in order to rotate the gearwheel 25 into the setting shown in FIG. 11, with the pin 26 in the 9 o'clock position. The control circuit recognises that this position is reached when the two light barriers 46, 47 are again open. The rib 45 is now able to be clearly seen in the figure for a major part of its length.

In this setting the compartments 4 of the tray 1 are downwardly open so that the pieces of ice contained therein can drop out. The already mentioned electrical heating device 13 is provided in order to facilitate detaching of the pieces of ice. As can be recognised in FIG. 12, this heating device 13 is an electric heating rod, which is bent into a loop and which extends in close contact with the tray 1 between heat exchange ribs 49 protruding at the underside thereof and is in part received in a groove 48 formed at the underside of the tray 1.

Through brief heating of the tray 1 with the help of the heating device 13 the pieces of ice in the compartments 4 are thawed at the surface. The water layer thus produced between the tray 1 and the pieces of ice acts as a slide film on which the pieces of ice are movable with very low friction. By virtue of the cross-sectional shape of the compartments 4 in the form of a segment of a cylinder the pieces of ice easily slide out of the compartments 4 and drop into a collecting container (not illustrated) arranged below the ice maker.

After emptying of the compartments 4, the drive motor is set back into operation and the gearwheel 25 further rotated in clockwise sense until it again reaches the setting shown in FIGS. 5 to 7 and a new operating cycle of the ice maker begins.

1-12. (canceled)

13. An ice-maker tray comprising a plurality of compartments arranged in a number of rows and separated from one another by partition walls, wherein a wall extending above the upper edges of the partition walls is formed at a longitudinal side of each row of compartments and at least a part of the transverse sides thereof.

14. The ice-maker tray according to claim 13, wherein the upper edges of the partition walls extend rectilinearly.

15. The ice-maker tray according to claim 13, wherein the number of rows is one.

16. The ice-maker tray according to claim 13, wherein the wall extends at least 5 millimeters above the upper edge of the partition walls.

17. The ice-maker tray according to claim 13, wherein the compartments have the form of a segment of a circle in cross-section.

18. The ice-maker tray according to claim 13, further comprising an electrical heating device.

19. The ice-maker tray according to claim 18, wherein the electrical heating device is a heating rod inserted between heat exchange ribs protruding from the tray.

20. The ice-maker tray according to claim 13, wherein the tray is pivotable about an axis in a frame of the ice maker between an upright setting in which the upper edges of the partition walls extend horizontally and a tilted setting in which they are inclined towards the longitudinal side having the protruding wall.

21. The ice-maker tray according to claim 20, wherein the pivot axis of the tray is the center axis of a smallest cylinder enclosing the tray.

22. The ice-maker tray according to claim 20, wherein the upper edges of the partition walls in the upright and the tilted setting lie above the pivot axis.

23. The ice-maker tray according to claim 20, wherein the tray is further pivotable into an emptying setting in which the openings of the compartments face downwardly.

24. A method of ice-making comprising filling water into an ice-maker tray and letting the water in the tray freeze, wherein prior to letting the freezing take place the ice-maker tray is pivoted from a tilted setting, in which the filled water floods over partition walls between compartments of the tray on a part of the width thereof and contacts a region of a longitudinal wall of the tray extending above the upper edges of the partition walls, to an upright setting, in which the level of the water lies below the upper edges of the partition walls.
